(19) United States
(12) Patent Application Publication
(10) Pub. No.: US 2023/0408726 A1
(43) Pub. Date: Dec. 21, 2023

(54) WEATHER FORECASTING USING TELECONNECTIONS

(71) Applicant: INTERNATIONAL BUSINESS MACHINES CORPORATION, ARMONK, NY (US)

(72) Inventors: Dario Augusto Borges Oliveira, Sao Paulo (BR); Bianca Zadrozny, RIO DE JANEIRO (BR); Campbell D Watson, Brooklyn, NY (US); Jorge Luis Guevara Diaz, Sao Paulo (BR)

(21) Appl. No.: 17/807,815

(22) Filed: Jun. 20, 2022

(51) Int. Cl. G01W 1/10

(52) U.S. Cl. CPC G01W 1/10

(57) ABSTRACT

A method, computer system, and a computer program for weather prediction are provided. The method may include receiving a first weather event associated with a first location. The present invention may further include inputting the first weather event into a machine learning model generated via mapping historical weather data into a latent space and via identifying, in the latent space, climate teleconnections amongst historical weather events at various locations. The method may further include in response to the inputting, receiving by the computing device a weather prediction for a second location, the weather prediction being based on a predicted climate teleconnection between the first location and the second location with respect to the first weather event, wherein the teleconnections machine learning model maps the first weather event into latent code for the latent space in order to generate the weather prediction for the second location.

### FIELD OF THE INVENTION

The present invention relates generally to the field of computer model weather forecasts, and more particularly to weather forecasting using artificial neural network models.

### BACKGROUND

Forecasting models may be utilized to evaluate historical weather associated with a geographic area in order to generate weather predictions relating to said geographic area. However, these weather predictions are subject to uncertainty due to atmospheric impacts derived from atmospheric factors such as sky conditions along with temporal impacts such as distinctions derived from the current time period and the time period the applicable forecast applies to. The aforementioned issues can result in forecasts that apply to misappropriate time windows or non-linear relationships across time windows. Naturally, these issues also inhibit the linking of disconnected weather anomalies across various locations referred to as teleconnections.

Accordingly, there is a need for a scalable automated means to connect weather anomalies across multiple geographic locations utilizing models that circumvent inefficiencies (e.g., incorrect predictions, misapplication of time windows, improper training, etc.)

### SUMMARY

Additional aspects and/or advantages will be set forth in part in the description which follows and, in part, will be apparent from the description, or may be learned by practice of the invention.

Embodiments of the present invention disclose a method, system, and computer program product for weather prediction is provided. A computer receives a first weather event associated with a first location. The computer further inputs the first weather event into a machine learning model, the machine learning model having been trained via mapping historical weather data into a latent space and via identifying, in the latent space, climate teleconnections amongst historical weather events at various locations. The computer further receives from the machine learning model a weather prediction for a second location, the weather prediction being based on a predicted climate teleconnection between the first location and the second location with respect to the first weather event, wherein the machine learning model maps the first weather event into latent code for the latent space in order to generate the weather prediction for the second location.

In some embodiments, the computing device is configured to train a neural network deep learning model to compute a time series modeling and the one or more time series forecasts. The use of a neural network increases the efficiency of the time series modeling and forecasting.

In some embodiments, the training of the deep learning model is unsupervised. The use of unsupervised training permits a broader recognition of patterns and aids in discovering hidden patterns.

In some embodiments, the system for weather prediction includes an encoder neural network and a decoder neural network configured to encode data into a latent space as data codes and decode the data codes in which the computer is configured to predict weather events pertaining to geographic locations based on teleconnections ascertained utilizing the data codes. The use of neural networks increases the efficiency of operations and facilitates training.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a functional block diagram illustrating a computational environment for weather prediction according to at least one embodiment;

FIG. 2 illustrates neural network incorporating external factors per time series, according to at least one embodiment;

FIG. 3 illustrates an exemplary block diagram illustrating a data flow associated with the environment of FIG. 1, according to at least one embodiment;

FIG. 4 illustrates a flowchart depicting a process for synthesizing teleconnections, in accordance with an embodiment of the invention;

FIG. 5 illustrates a flowchart depicting a process for weather prediction, in accordance with an embodiment of the invention;

FIG. 6 depicts a block diagram illustrating components of the software application of FIG. 1, in accordance with an embodiment of the invention;

FIG. 7 depicts a cloud-computing environment, in accordance with an embodiment of the present invention; and

FIG. 8 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

As described herein, the term “latent space” refers to a multi-dimensional space including feature values that are not directly interpreted, but such feature values are used to encode a meaningful internal representation of externally observed events. In addition, the term “a lower-dimensional latent space” refers to a reduction of an original spectral dimension to increase the efficiency of a search. In other words, the latent space is a collection of deep structural patterns that include high explanatory value in portraying the variability of time series over space and time.

As described herein, a “time series” is a sequence of data points taken at successive equally spaced points in time. “Time series forecasting” relates to the use of artificial intelligence to predict future values based on previous observed values. Time series data has a natural temporal ordering.

As described herein, a “data code” is a product of dimensionality reduction in which information from an initial space is compressed into data points within a latent space in a manner in which the result of the compression is an encodable reference to said information. Due to the encoding process encoding inputs as distributions over the latent space, the data codes are samples of the respective distributions.

The following described exemplary embodiments provide a method, computer system, and computer program product for weather prediction. Modeling and forecasting across massive amounts of time-series has multiple limitations regarding factors such as computing resources, prediction accuracies, and time application (e.g., time constraints, incorrect time windows, etc.). In particular, efficiently and accurately predicting weather across multiple geographic locations encounters a myriad of issues due to volatile geographic-specific issues such as temporal shifts and weather impactors (e.g., atmospheric pressure, sea surface temperatures, etc.), in addition to the aforementioned factors also impacting the amount of time to process the voluminous amounts of data in real-time. For example, the combination of voluminous sources of historical climate data, the integration of abundant spatial-temporal data, and misapplication of causal analyses may directly impact predictions relating to a specific geographic area, much less teleconnections derived from said predictions. Teleconnections may be established via models; however, the variability of time, weather, and location not only directly impacts the accuracy of these teleconnections, but also imposes limitations on the models from a computing/processing standpoint. As such, the present embodiments have the capacity to perform weather predictions across various geographic locations in a manner that not only increases the accuracy of teleconnections by accounting for temporal shifts, but also reduces the amount of computing processing and power requirements to perform the aforementioned by utilizing lower dimensional spaces to map unconventional data codes representative of weather events and decoding the data codes which facilitates synthesized weather events.

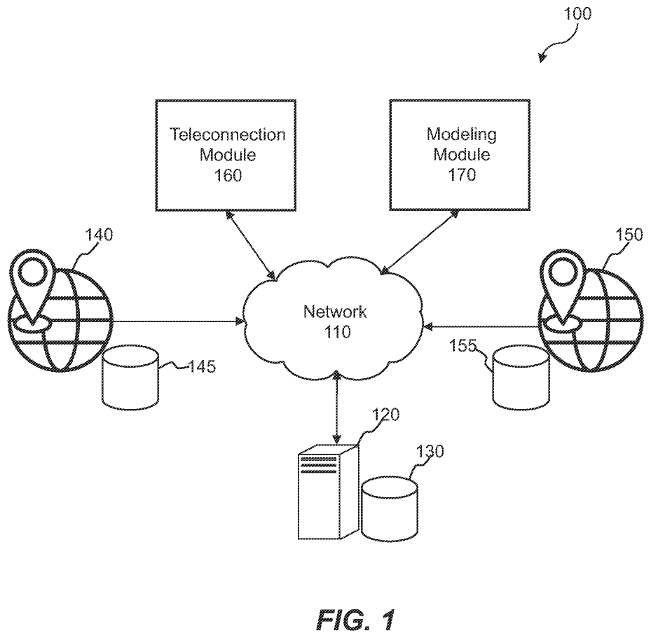

Referring now to FIG. 1, an environment for predicting weather 100 is depicted according to an exemplary embodiment. FIG. 1 provides only an illustration of implementation and does not imply any limitations regarding the environments in which different embodiments may be implemented. Modifications to environment 100 may be made by those skilled in the art without departing from the scope of the invention as recited by the claims. In some embodiments, environment 100 includes a server 120 communicatively coupled to a database 130, a first geographic location 140, a first geographic location historical climate data database 145 associated with first geographic location 140, second geographic location 150, a second geographic location historical climate data database 155 associated with second geographic location 140, a teleconnection module 160, and a modeling module 170, each of which are communicatively coupled over a network 110. Network 110 may include various types of communication networks, such as a wide area network (WAN), local area network (LAN), a telecommunication network, a wireless network, a public switched network and/or a satellite network, etc. In some embodiments, network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. It should be appreciated that FIG. 1 provides only an illustration of one implementation and does not imply any limitations with regard to the environments in which different embodiments may be implemented. Many modifications to the depicted environments may be made based on design and implementation requirements.

In some embodiments, first geographic location historical climate data database 145 and second geographic location historical climate data database 155 are configured to include a plurality of time-series data pertaining to the respective geographic locations (or others locations, if applicable, in various embodiments of the invention). The time-series data stored by database 145 and database 155 is derived from sources including but not limited to weather/climate agencies, external databases accessed by one or more crawlers associated with server 120, climate research organizations, satellite-based systems, crowd-sourcing systems, sensor-based systems, or any other applicable weather/climate data source known to those of ordinary skill in the art. For descriptive purposes, server 120 is designed to transmit one or more data feeds sourced from first geographic location historical climate data database 145 and/or second geographic location historical climate data database 155 in order for modeling module 170 to train a neural network deep learning model to compute time series models; however, the time series models may be built based on the time series values with any suitable and known model building method. The time series models may have many forms and represent different stochastic processes. The one or more data feeds may include textual data, image data, climate data (e.g., temperature, wind speed, precipitation, etc.) or any other applicable type of data and/or combination thereof sourced from first geographic location historical climate data database 145 and/or second geographic location historical climate data database 155 in which said data feeds may represent one or more weather events and/or derivatives thereof associated with the respective geographic locations. In some embodiments the one or more data feeds include input climate data images accounting for spherical images, 2D planar images, or any other applicable data image configured to be processed by a neural network. It should be noted that modeling module 170 functions as an autoencoder configured to utilize data training to regularize encoding distribution in order to support a latent space designed for efficient data generation. In some embodiments, modeling module 170 inputs data from the data feeds within the models as time-series data accounting for periodic samples of weather events. Server 120 and/or modeling module 170 are configured to detect and extract components and/or impacts within the climate data images including but not limited to mortal contributions (e.g. greenhouse gases, deforestation, overpopulation, etc.), land surface elements (hydrology, vegetation, precipitation coverage, etc.); atmospheric impacts (nimbus-related data, etc.), sea ice elements (radiation absorption, heat exchange between ocean and atmosphere, etc.), or any other applicable ascertainable climate data image features known to those of ordinary skill in the art. In some embodiments, each data feed is configured to include a distinct type of data; however, the data feeds may be encoded into one or more vectors configured to be representative of weather events. For example, two data feeds derived from first geographic location historical climate data database 145 may have distinct types of data in which the one data feed includes textual data and the other data feed includes times series data associated with a weather event at first geographic location 140. Both forms of data may be aggregated into one or more vectors representative of the weather event at the respective geographic location.

Server 120 is configured to support functions such as natural language processing (NLP), image processing, encoding/decoding, noise reducers, or any other applicable functions configured to optimize data for transmission of data feeds from databases 145 and 155 along with applicable third party databases accessible by server 120. In addition, server 120 is configured to generate a centralized platform designed to allow users to access components of environment 100 such as user inputs (e.g., hypothesis, prior knowledge, analytics review, etc.). It should be noted that server 120 may perform aggregation, filtration, optimization, etc. of data derived from databases 145 and 155 and other applicable databases in order to generate the data feeds and store them in database 130 in which the data feeds are transmitted to modeling module 170 for training and processing. Teleconnection module 160 is communicatively coupled to modeling module 170 and is configured to identify causal connections/correlations between source and target datasets; however, one of the purposes of teleconnection module 160 is to ascertain correlated weather events based on data received from historical climate data sources and any other applicable source. For example, teleconnection module 160 may monitor extreme weather events at first geographic location 140 and other applicable geographic locations over periods of time in order to predict a weather event associated with second geographic location 150 based on a plurality of tele-connected extreme weather events. Modeling module 170 is configured to be data agnostic allowing different types of climate data to seamlessly be used within the same framework regardless of specific characteristics such as time, location, etc.

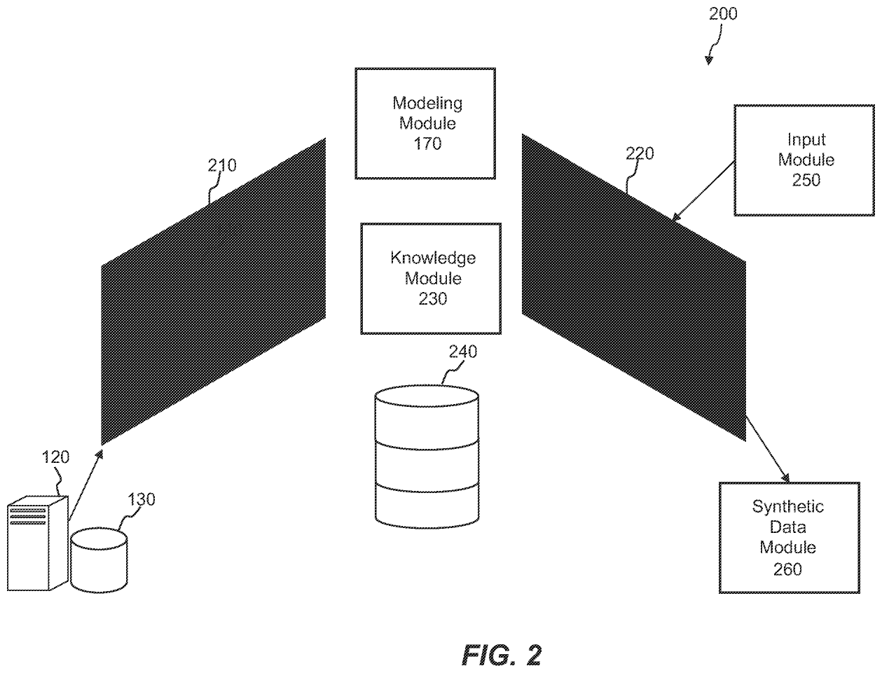

Referring now to FIG. 2, an architecture 200 for a neural network of environment 100 is depicted, according to an exemplary embodiment. In some embodiments, modeling module 170 includes an encoder 210 and a decoder 220 in which each of encoder 210 and decoder 220 are neural networks operated by modeling module 170 in order to facilitate mapping of weather events ascertained from the data feeds to the latent space. The latent space may be a derivative of an original spectral dimension to increase the efficiency of searching/crawling, and the combination of encoder 210 and decoder 220 seek to create a bottleneck for data derived from the data feeds by performing gradient descent iterations to reduce the reconstruction error; thus, supporting modeling module 170 mapping the plurality of data codes in the latent space. Modeling module 170 is configured to train one or more neural network deep learning models including but not limited to recurrent neural networks (RNN), temporal convolutional neural networks (TCNs), gated recurrent unit (GRU), long short-term memory (LSTM), variational autoencoders (VAEs), generative adversarial networks (GANs), or any other applicable deep learning models. Data derived from the data feeds is utilized during training processes of modeling module 170; however, server 120 may label the data allowing modeling module 170 to train the weights of each of the layers of the applicable data model of modeling module 170. In some embodiments, architecture 200 may include a knowledge module 230 which includes a prior knowledge database and a knowledge operator configured to function as an equalizer for the applicable neural network. For example, knowledge module 230 may utilize weights from previous and current neural networks in order for the knowledge operator to train classifiers for making applicable predictions (e.g. labels, etc.). The labels may be applied during the encoding process in which encoder 210 assigns a plurality of data codes to each weather event associated with first geographic location 140 ascertained from the applicable data feeds. Encoder 210 encodes the applicable data derived from the data feeds as distributions across the latent space resulting in the plurality of data codes. In some embodiments, data derived from the data feeds may be applied to one or more layers of the applicable neural network operated by modeling module 170.

Modeling module 170 performs mapping in the latent space by performing contrastive learning on the climate data. As previously stated, the resulting output of encoder 210 is the plurality of data codes in which each of the data codes are encoded and are representative and/or an identifier of one or more samples of a weather event. Modeling module 170 is configured to perform the mapping to the latent space in a manner in which it regularizes the covariance matrix and the mean of the distributions returned by encoder 210 in order to prevent overfitting. Modeling module 170 performs this by enforcing distributions in close proximity to a standard normal distribution.

Modeling module 170 clusters the vectors of weather events based on similarity/commonality of one or more elements of the weather events in which the clusters are correlated groups based upon content, context, etc. For example, weather events associated with heavy rain within first geographic location 140 (e.g., precipitation levels above a threshold) may be clustered despite occurring across various periods of time. In some embodiments, the vectors are sequentially ordered based on a corresponding time stamp associated with each vector (e.g., time data was received by a sensor, day of the weather event, etc.). Clustering may be performed based one or more similarity measures including but not limited to Euclidean distance, Manhattan distance, dynamic time warping (DTW) distance, Minkowski Distance, Cosine distance, Correlation coefficients (e.g. Pearson, Spearman), expectation maximization with a Gaussian mixture model, or any other applicable similarity measuring mechanism known to those of ordinary skill in the art. It should be noted that one of the purposes of clustering weather events is to allow teleconnection module 160 to generate predictions of weather events associated with second geographic location 150 based on at least data derived from first geographic location historical climate data database 145. In some embodiments, while modeling module 170 is deploying the deep learning models server 120 and/or teleconnection module 160 is configured to extract features from first geographic location historical climate data database 145 and/or second geographic location historical climate data database 155 in which the features include but are not limited to functional dependencies, correlations, spatial-temporal data, sensor type of applicable sensor data was collected on, climate variables, area covered size, data resolution, image quality, noise level, land cover usage, or any other ascertainable features known to those of ordinary skill in the art.

Teleconnection module 160 stores the one or more predicted teleconnections in a teleconnection database 240 in which teleconnection database 240 is designed to be crawled via a teleconnections crawler configured to validate a plurality of teleconnection hypotheses. In some embodiments, a plurality of hypotheses may be automated inferences or targets generated by a hypotheses module communicatively coupled to teleconnection module 160, in which the hypotheses module is utilized by modeling module 170 during the training phase. In some embodiments, the hypotheses are derived from an input module 250 designed to ascertain the hypotheses from a plurality of inputs provided by users on a computing device operating the centralized platform, or the teleconnection hypotheses may be based on a combination of data derived from the prior knowledge database and/or input module 250. For example, the hypotheses module may receive from input module 250 user inputs such as but not limited to a geographic region of interest for where the teleconnections will be analyzed, a range of valid temporal shifts, and/or combinations of weather data pertaining to first geographic location 140 and second geographic location 150 accounting for the temporal shifts. It should be noted that the hypotheses module enables modeling module 170 to perform clustering of weather event representations within the latent space into vectors based upon context/content, location, temporal shifts, and/or a combination thereof.

In some embodiments, the clustering of vectors within the latent space results in teleconnection database 240 characterization, in which vectors may include similar differences for the latent representations of weather data events integrating the locations and the temporal shifts (i.e., all combinations of time and temporal shift within the geographic location). Knowledge module 230 is communicatively coupled to teleconnection module 160 allowing the teleconnections crawler to validate one or more hypotheses based on at least data derived from the prior knowledge database. Input module 250 is further designed to support interaction and customization of one or more attributes or mechanisms of architecture 200 via the centralized platform. For example, manipulation of data utilized by modeling module 170 may be necessary in order to ascertain the optimal accuracy for curation of teleconnections that provide the best prediction of a weather event associated with second geographic location 150 based on the results of the teleconnection crawl searching teleconnection database 240. Target prediction times specified by users or a hypothesis allow modeling module 170 to operate models that include a designated time period for which a predicted weather event occurs. For example, a cluster may contain similar differences for the latent representation of A_t vs B_(t+shift), in which t represents time of weather event, A represents a first geographic location, B represents a second geographic location, shift represents the temporal shift, and wherein the computation is performed for t, shift, and A & B within a designated region of interest. In a preferred embodiment, the predicted teleconnection is one of the estimated valid teleconnections for code A B+temporal shift. Server 120 ultimately simulates weather scenarios for the predicted B that would happen at temporal shift t.

Server 120 identifies a plurality of temporal shifts within data derived from one or more of database 130, first geographic location historical climate data database 145, the prior knowledge database, and/or input module 250 in order to normalize time associated with weather events of geographic locations. The temporal shifts account for time windows of weather events in which the ascertainable difference in time and other ascertainable weather-related data between samples of weather events associated with first geographic location 140 are integrated into the processing of modeling module 170 and used to predict a weather event associated with second geographic location 150.

Decoder 220 is designed to decode the plurality of data codes in order for a synthetic data module to generate a plurality of synthetic climate data associated with a predicted weather event pertaining to second geographic location 150. It should be noted that the plurality of synthetic climate data may be a representation of a predicted weather event associated with second geographic location 150 or data utilized by server 120 to generate a predicted weather event based on the optimal model(s) generated by modeling module 170 and teleconnections detected by the teleconnections crawler within teleconnection database 240.

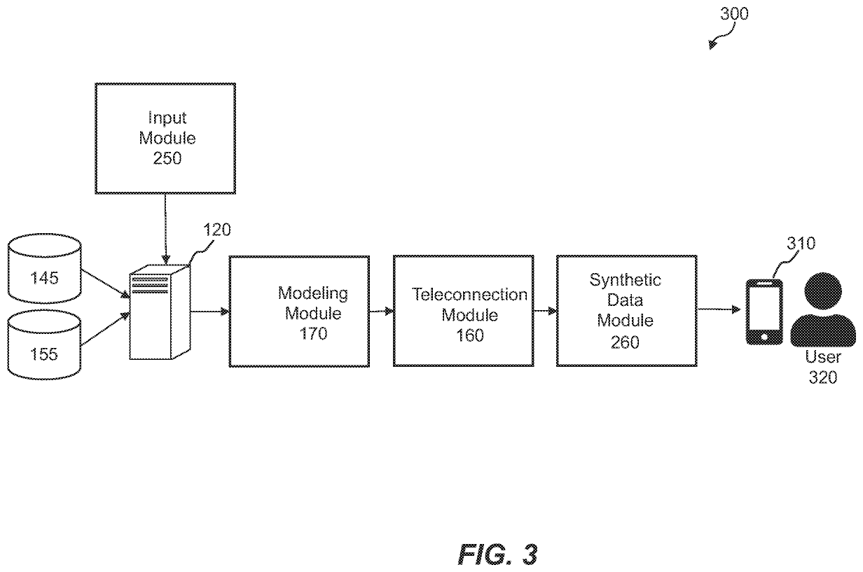

Referring now to FIG. 3, a data flow 300 associated with weather prediction environment 100 is depicted, according to an exemplary embodiment. Data feeds derived from first geographic location historical climate data database 145, second geographic location historical climate data database 155, and any other applicable data source configured to be crawled by one or more crawlers associated with server 120 are received and analyzed by server 120 allowing modeling module 170 to begin the modeling process. The analysis may be iterative and asynchronously allowing fusion of features from the data feeds. For example, combining of vectors derived from the respective data feeds based on correlations derived from temporal elements of weather events. Server 120 continuously transmits received data to modeling module 170 for training while receiving hypotheses from a user 320 via input module 250 provided by the centralized platform operating on a user computing device 310. Input module 250 may provide one or more graphical interfaces on the centralized platform in order to not only receive inputs from user 320, but also to provide user 320 with a means to view analytics, performance metrics, feedback, or any other applicable data of environment 100 via the centralized platform. For example, user 320 may utilize the centralized platform to receive the plurality of hypotheses configured to inform server 120 of a target location (e.g., second geographic location 150) and temporal window for the purpose of server 120 instructing modeling module 170 to train encoder 210 accordingly. Server 120 providing these instructions allows modeling module 170 to automatically adapt to weather data observed in second geographic location 150 considering the temporal window defined by user 320. Computing device 310 can be implemented in the form of any system including a processor and memory that is capable of performing the functions and/or operations described within this specification. For example, computing device 310 can be, for example, an e-book reader, a tablet computer, a smart phone, a mobile computer, a laptop computer, a netbook computer, a desktop computer, or any applicable type of computing devices capable of running a program, accessing a network, and/or accessing databases.

Modeling module 170 iteratively not only trains applicable datasets and operates the respective models, but also utilizes the latent space to assist with generation of outputs that represent missing variables through successive iterations. For example, modeling module 170 may output prediction samples of weather events based on one or more latent variables in the latent space, which may be calculated from predicated latent samples. It should be noted that modeling module 170 utilizes encoder 210 to not only encode the weather events for mapping into the latent space, but also for efficiency purposes in which encoder 210 cleans/de-noises applicable data and determines applicable weights for weather data within the data feeds. The encoder 210 ultimately reduces the amount of data that decoder 220 has to decode.

Modeling module 170 selects the applicable model identified by server 120 based on the relevant weather data and associated location, which in some instances is provided by user 320 via input module 250. In some embodiments, server 120 identifies the applicable model based upon location of the weather event, content/context similarity, or any other applicable factor. Modeling module 170 may be used to fill gaps of information via predictions based on data derived from previous models. Once the applicable model is selected, the weather event and/or samples thereof are mapped in the latent space by modeling module 170 via encoder 210 encoding the applicable weather data and assigning said data the plurality of data codes. Within the latent space, teleconnection module 160 is continuously ascertaining teleconnections by monitoring teleconnection patterns within data collected from various geographic locations across various periods of time. For example, changes to the atmosphere and/or ocean may significantly impact the weather of first geographic location 140, or changes to the amount of clouds associated with first geographic location 140 may significantly impact the weather of second geographic location 150. Teleconnection module 160 is configured to account for modifications caused by temporal effects, significant climate changes, etc. Furthermore, the one or more hypotheses are utilized to map two correlated weather events closely within the latent space, while contrastive learning is utilized to optimize internally the agreement in the latent space between the two weather events (e.g., at different times)

Server 120 stores the plurality of data codes in database 130 in which the data codes are encoded samples of the weather data and the teleconnection crawler utilizes the data codes to query teleconnection database 240. In addition to including teleconnections, teleconnection database 240 may also include correlations with known teleconnection indices. In particular, the plurality of data codes may be references to the weather events in which data derived from the correlations are accounted for in the data codes prior to the data codes being decoded by decoder 220. In some embodiments, nodes of the one or more layers of the applicable neural network operated by modeling module 170 represent vectors of the time series values, in which at least one of the vectors is a temporal vector. Teleconnection database 240 outputs the applicable teleconnection; however, it is because of the cluster of paired differences within the latent space that are assigned respective data codes that allows the optimal weather event of first geographic location 140 to be ascertained. As teleconnection module 160 retrieves suitable teleconnections based on the combination of data received from input module 250 (e.g., desired geographic location, applicable timeframe, etc.), data derived from prior knowledge database, database 130, and/or any other applicable data source, modeling module 170 is continuously using inferences to support creation of vectors including paired differences via server 120.

Decoder 220 is configured to decode the plurality of data codes based upon the result of the query of teleconnection database 240. It should be noted that the decoding process ascertains one or more sets of values pertaining to second geographic location 150 integrating the plurality of temporal shifts in which the sets of values are congruent with the weather data ascertained from the plurality of data codes pertaining to first geographic location 140 except for the integration of the plurality of temporal shifts and data specific to second geographic location 150. The results of the decoded plurality of data codes are transmitted to synthetic data module 260 in which synthetic data module 260 is configured to generate a predicted weather event associated with second geographic location 150 based on the aforementioned (e.g. region of interest, temporal shifts, etc.). The predicted weather event is configured to be presented to user 320 via user interfaces on the centralized platform operated by computing device 310.

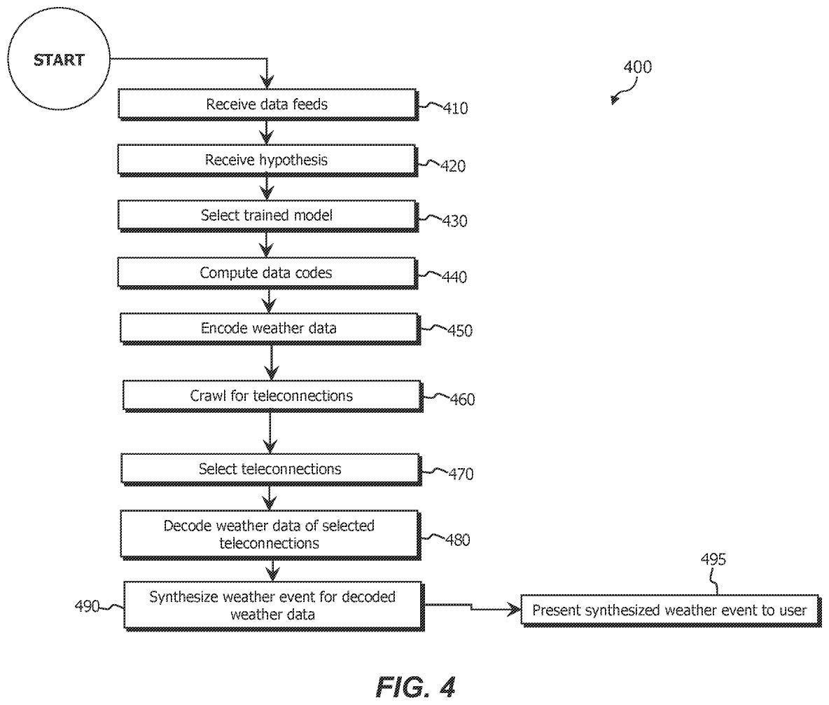

Referring now to FIG. 4, an operational flowchart illustrating an exemplary process for synthesizing teleconnections 400 is depicted, according to an exemplary embodiment. At step 410 of process 400, server 120 receives the one or more data feeds derived from first geographic location historical climate data database 145, second geographic location historical climate data database 155, database 130, and/or any other applicable data source configured to be accessed by crawlers associated with 120. It should be noted that teleconnections may be ascertained based upon a plurality of geographic locations composing a region of interest, in which the region of interest does not necessarily require a geographic limitation.

At step 420 of process 400, server 120 receives the plurality of hypotheses from the hypotheses module. In some embodiments, the hypotheses are derived from input module 250 in which user 320 provides at least a geographic region of interest for where the teleconnections will be analyzed and/or a range of valid temporal shifts relating to a geographic area.

At step 430 of process 400, modeling module 170 selects the applicable trained model relating to the geographic location ascertained from input module 250, in which the selection of the model may be based upon similarity of contextual information associated with the applicable weather events and/or weather data ascertained during step 410. In some embodiments, user 320 selects the applicable trained model from a list of pretrained models configured to be filtered by criteria selected by user 320 (e.g., data, type of weather event, etc.).

At step 440 of process 400, server 120 instructs modeling module 170 to train encoder 210 and decoder 220 in order for server 120 to compute the plurality of data codes, in which the training process will include one or more elements of the geographic location specified based on data derived from input module 250. For example, the training process includes weather data associated with second geographic location 150. In some embodiments, the trained models are stored in database 130 along with contextual information used during the training such as geographic location and time window. In some embodiments, the plurality of data codes are computed based on encoder 210 which has been trained by modeling module 170.

At step 450 of process 400, server 120 instructs encoder 210 to encode the weather data representative of samples of weather events derived from the applicable model selected in step 430 into the latent space. The encoding of the weather data includes encoder 210 assigning the plurality of data codes across the weather data. In a preferred embodiment, each weather event is assigned at least one data code; however, a single data code may be assigned the multiple weather events based upon one or more similarities detected among the weather events.

At step 460 of process 400, server 120 instructs teleconnection module 160 to begin the process of searching for teleconnections that align with at least one of the hypotheses derived from the hypothesis module. As described herein, a hypothesis is a user input representing future weather predictions pertaining to a geographic location. In some embodiments, the teleconnections crawler utilizes the plurality of data codes to query teleconnection database 240 and the teleconnections crawler utilizes a contrastive learning neural network or any other applicable machine learning techniques used to learn the general features of a dataset without labels via teaching the model which data points are similar or different, as part of the teleconnection database 240 crawling process. In some embodiments, teleconnection module 160 instructs the hypotheses module to perform a validation process in order for server 120 to cluster the one or more vectors. The clustering process may be based upon one or more paired differences between sets of weather data in which the paired differences may pertain to distinctions in geographic locations, time window, temporal shifts, or any other ascertainable data and/or metadata derived from database 130, first geographic location historical climate data database 145 and second geographic location historical climate data database 155, the prior knowledge database, and/or any other applicable data source.

At step 470 of process 400, teleconnection module 160 selects the applicable teleconnection within teleconnection database 240 in response to the teleconnection crawler detecting the teleconnection that aligns with the applicable data. It should be noted that the detected teleconnection is a representation of a relevant predicted weather event associated with second geographic location 150 based on weather events associated with first geographic location 140. The teleconnection is detected based upon at least one of the clustered pair differences, temporal shifts, weather event context/content, etc. Selected teleconnections may be stored in database 130.

At step 480 of process 400, decoder 220 decodes the applicable data code associated with the teleconnection selected by teleconnection module 160 into realistic data. Realistic data may include but not is not limited to synthesized data representing spatial-temporal statistical properties or any other applicable variations of data resembling that within first geographic location historical climate data database 145 and second geographic location historical climate data database 155 (e.g., historical weather data from applicable sources). In some embodiments, during this decoding step random noise samples are decoded to provide predictive distributions which are configured to be integrated into the realistic data. It should be noted that the realistic data is configured to be a representation and/or utilized to generate a weather event prediction associated with second geographic location 150. The predictions can include any properties of the joint distribution—including the mean or median, variance, different quantiles, etc. Encoder 210 and decoder 220 are designed to be communicatively coupled through modeling module 170 in order to ensure that modeling module 170 is continuously optimizing/reducing the size of output data as a result of the decoding compared to the size of the input data being encoded via encoder 210. This configuration allows not only the reduction of computing resources necessary for server 120 to sustain processing, but also increases the efficiency of operations because decoder 220 has smaller amount of data to process.

At step 490 of process 400, synthetic data module 260 utilizes the decoded data and generates synthesized realistic weather field data representing a weather event pertaining to second geographic location 150 in accordance with the data derived from input module 250. For example, the synthesized realistic weather field data may be a set of points indexed by two-dimensional coordinates (e.g., latitude and longitude) visualized by images.

At step 495 of process 400, server 120 presents the synthesized realistic weather field data to user 320 via the centralized platform operating on computing device 310. The synthesized realistic weather field data may be presented via one or more graphical representations including but not limited to graphs, charts, weather map visualizations, interactive text data, or any other applicable graphical representation known to those of ordinary skill in the art. The synthesized realistic weather field data may be used by one or more down-stream systems including but not limited to insurance weather-aware risk modeling software, agricultural counter-measuring systems, traffic data platforms, flood management systems, etc.

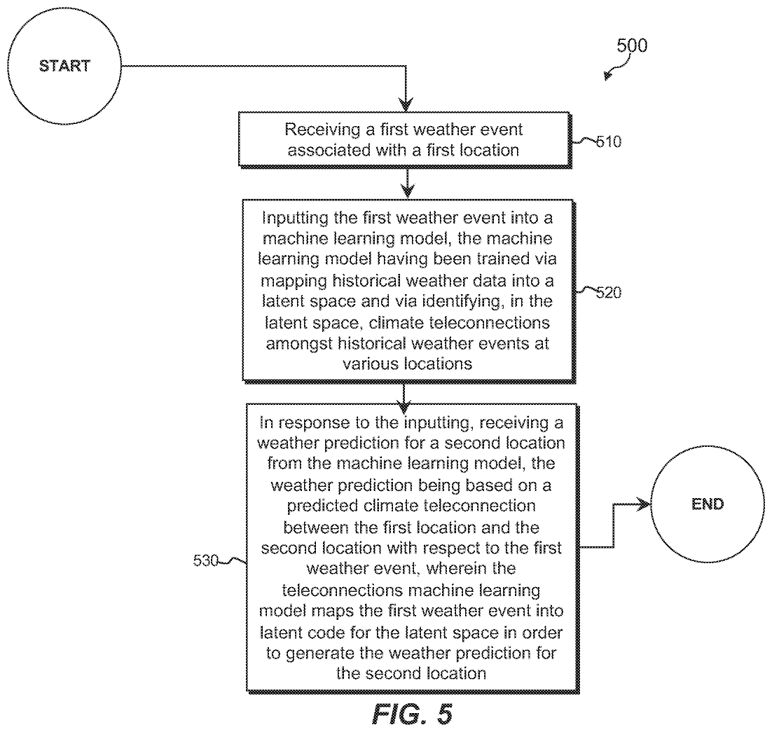

With the foregoing overview of the example architecture, it may be helpful now to consider a high-level discussion of an example process. FIG. 5 depicts a flowchart 500 illustrating a computer-implemented method of predicting weather, consistent with an illustrative embodiment. Process 500 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 510 of process 500, server 120 receives a first weather event associated with first geographic location 140. However, server 120 may receive weather events and/or an aggregation of similar weather events from a plurality of geographic locations in order to ascertain a predicted weather event for a region of interest specified by input module 250.

At step 520 of process 500, server 120 inputs the first weather event into a machine learning model operated by the modeling module 170. In some embodiments, the machine learning model having been trained by mapping historical weather data into the latent space, which allows server 120 to identify climate teleconnections amongst historical weather events at various locations within the latent space.

At step 530 of process 500, server 120 receives a weather prediction for second location 150, the weather prediction being based on a predicted climate teleconnection between the first location and the second location with respect to the first weather event, wherein the teleconnections machine learning model maps the first weather event into latent code for the latent space in order to generate the weather prediction for second geographic location 150.

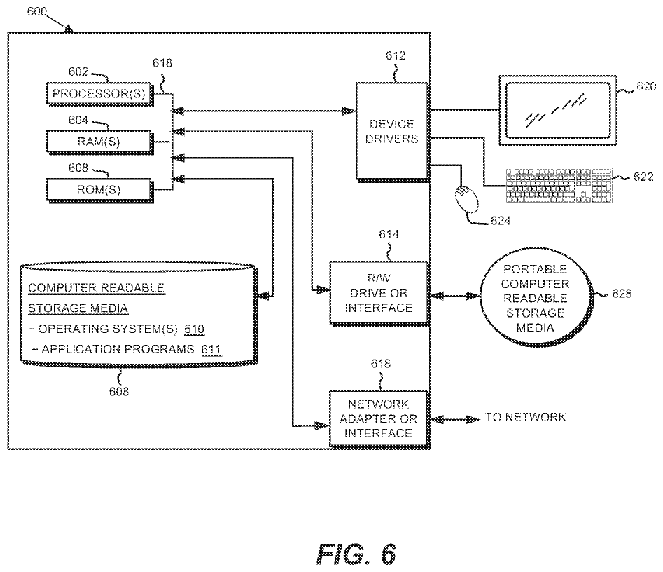

FIG. 6 is a block diagram of components 600 of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 602, 604 is representative of any electronic device capable of executing machine-readable program instructions. Data processing system 602, 604 may be representative of a smart phone, a computer system, PDA, or other electronic devices. Examples of computing systems, environments, and/or configurations that may represented by data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The one or more servers may include respective sets of components illustrated in FIG. 6. Each of the sets of components include one or more processors 602, one or more computer-readable RAMs 608 and one or more computer-readable ROMs 610 on one or more buses 602, and one or more operating systems 614 and one or more computer-readable tangible storage devices 616. The one or more operating systems 614 and computing event management system 210 may be stored on one or more computer-readable tangible storage devices 616 for execution by one or more processors 602 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices 616 is a semiconductor storage device such as ROM 610, EPROM, flash memory or any other computer-readable tangible storage device that can store a computer program and digital information.

Each set of components 600 also includes a R/W drive or interface 614 to read from and write to one or more portable computer-readable tangible storage devices 608 such as a CD-ROM, DVD, memory stick, magnetic tape, magnetic disk, optical disk or semiconductor storage device. A software program, such as computing event management system 210 can be stored on one or more of the respective portable computer-readable tangible storage devices 608, read via the respective RAY drive or interface 618 and loaded into the respective hard drive.

Each set of components 600 may also include network adapters (or switch port cards) or interfaces 616 such as a TCP/IP adapter cards, wireless wi-fi interface cards, or 3G or 4G wireless interface cards or other wired or wireless communication links. Applicable software can be downloaded from an external computer (e.g., server) via a network (for example, the Internet, a local area network or other, wide area network) and respective network adapters or interfaces 616. From the network adapters (or switch port adaptors) or interfaces 616, the centralized platform is loaded into the respective hard drive 608. The network may comprise copper wires, optical fibers, wireless transmission, routers, firewalls, switches, gateway computers and/or edge servers.

Each of components 600 can include a computer display monitor 620, a keyboard 622, and a computer mouse 624. Components 600 can also include touch screens, virtual keyboards, touch pads, pointing devices, and other human interface devices. Each of the sets of components 600 also includes device processors 602 to interface to computer display monitor 620, keyboard 622 and computer mouse 624. The device drivers 612, R/W drive or interface 618 and network adapter or interface 618 comprise hardware and software (stored in storage device 604 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

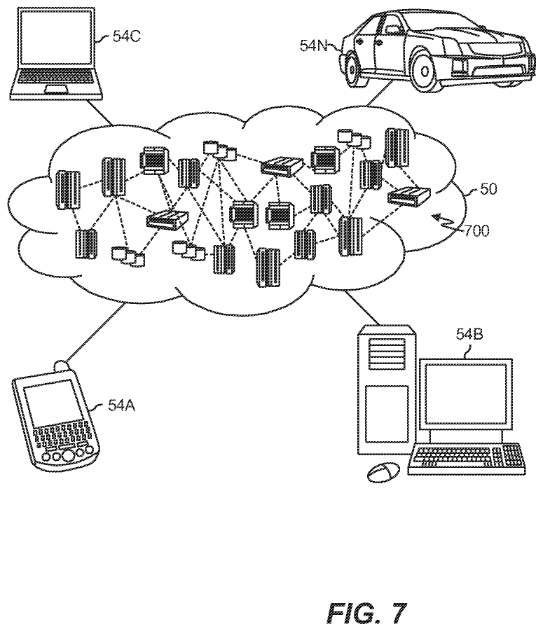

Referring now to FIG. 7, illustrative cloud computing environment 700 is depicted. As shown, cloud computing environment 700 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 54A-N shown in FIG. 7 are intended to be illustrative only and that computing nodes 50 and cloud computing environment 700 can communicate with any type of computerized device over any type of network and/or network addressable connection (e.g., using a web browser).

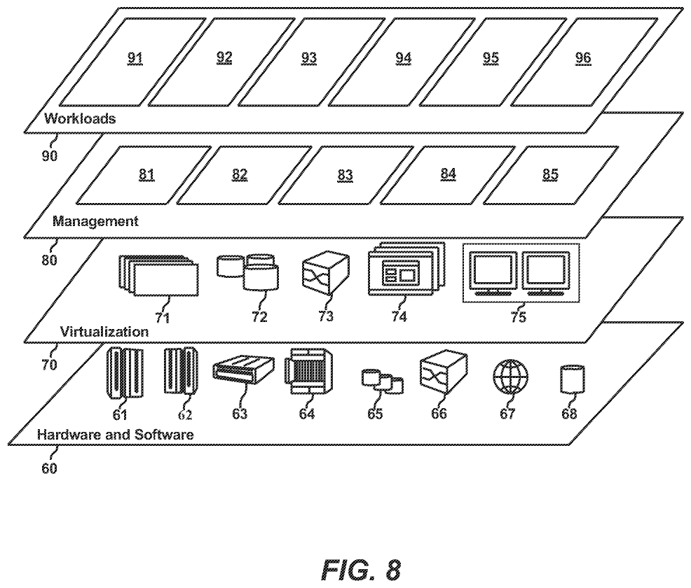

Referring now to FIG. 8 a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 66 and database software 68.

Virtualization layer 60 provides an abstraction layer from which the following examples of virtual entities may be provided: virtual servers 61; virtual storage 62; virtual networks 63, including virtual private networks; virtual applications and operating systems 64; and virtual clients 65.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for weather prediction, the method comprising:
receiving, by a computing device, a first weather event associated with a first location;
inputting, by the computing device, the first weather event into a machine learning model, the machine learning model having been trained via mapping historical weather data into a latent space and via identifying, in the latent space, climate teleconnections amongst historical weather events at various locations; and
receiving by the computing device from the machine learning model a weather prediction for a second location, the weather prediction being based on a predicted climate teleconnection between the first location and the second location with respect to the first weather event, wherein the machine learning model maps the first weather event into latent code for the latent space in order to generate the weather prediction for the second location.

2. The computer-implemented method of claim 1, wherein identifying climate teleconnections comprises:
receiving, by the computing device, at least one hypothesis;
identifying, by the computing device, relevant data associated with a plurality of data codes associated with the first weather event based on the hypothesis; and
generating, by the computing device, a plurality of clusters wherein the plurality of clusters include correlation data associated with the correlating of the first weather event and a second weather event associated with the second location based on the relevant data.

3. The computer-implemented method of claim 2, wherein inputting the first weather event further comprises:
receiving, by the computing device, a temporal shift between the first weather event and a previous weather event; and
identifying, by the computing device, the plurality of data codes associated with the second location within the latent space based on the plurality of clusters.

4. The computer-implemented method of claim 3, wherein inputting the first weather event further comprises:
storing, by the computing device, the temporal shift in a teleconnections database;
identifying, by the computing device, the plurality of data codes based on at least the temporal shift; and
generating, by the computing device, a plurality of synthetic data associated with the second location based on the identified data codes.

5. The computer-implemented method of claim 4, wherein the teleconnections database is configured to store the climate teleconnections and the computing device is configured to crawl the climate teleconnections utilizing a contrastive neural network.

6. The computer-implemented method of claim 1, wherein the plurality of data codes are configured to be encoded and decoded via a neural network.

7. The computer-implemented method of claim 4, wherein the plurality of synthetic data is used to generate the weather prediction for the second location based on at least one teleconnection in the teleconnections database.

8. A computer system for weather prediction, the computer system comprising:
one or more processors, one or more computer-readable memories, and program instructions stored on at least one of the one or more computer-readable memories for execution by at least one of the one or more processors to cause the computer system to:
program instructions to receive a first weather event associated with a first location;
program instructions to input the first weather event into a machine learning model, the machine learning model having been trained via mapping historical weather data into a latent space and via identifying, in the latent space, climate teleconnections amongst historical weather events at various locations; and
program instructions to receive from the machine learning model a weather prediction for a second location, the weather prediction being based on a predicted climate teleconnection between the first location and the second location with respect to the first weather event, wherein the machine learning model maps the first weather event into latent code for the latent space in order to generate the weather prediction for the second location.

9. The computer system of claim 8, wherein program instructions to identify climate teleconnections further comprises program instructions to:
receive at least one hypothesis;
identify relevant data associated with a plurality of data codes associated with the first weather event based on the hypothesis; and
generate a plurality of clusters wherein the plurality of clusters include correlation data associated with the correlating of the first weather event and a second weather event associated with the second location based on the relevant data.

10. The computer system of claim 9, wherein program instructions to input the first weather event further comprises program instructions to:
receive a temporal shift between the first weather event and a previous weather event; and
identify the plurality of data codes associated with the second location within the latent space based on the plurality of clusters.

11. The computer system of claim 10, wherein program instructions to input the first weather event further comprises program instruction to:
store the temporal shift in a teleconnections database;
identify the plurality of data codes based on at least the temporal shift; and
generate a plurality of synthetic data associated with the second location based on the identified data codes.

12. The computer system of claim 11, wherein the teleconnections database is configured to store the climate teleconnections and the climate teleconnections are configured to be crawled utilizing a contrastive neural network.

13. The computer system of claim 8, wherein the plurality of data codes are configured to be encoded and decoded via a neural network.

14. The computer system of claim 11, wherein the plurality of synthetic data is used to generate the weather prediction for the second location based on at least one teleconnection in the teleconnections database.

15. A computer program product using a computing device for weather prediction, comprising:
one or more non-transitory computer-readable storage media and program instructions stored on the one or more non-transitory computer-readable storage media, the program instructions, when executed by the computing device, cause the computing device to perform a method comprising:
receiving, by a computing device, a first weather event associated with a first location;
inputting, by the computing device, the first weather event into a machine learning model, the machine learning model having been trained via mapping historical weather data into a latent space and via identifying, in the latent space, climate teleconnections amongst historical weather events at various locations; and
receiving, by the computing device from the machine learning model, a weather prediction for a second location, the weather prediction being based on a predicted climate teleconnection between the first location and the second location with respect to the first weather event, wherein the machine learning model maps the first weather event into latent code for the latent space in order to generate the weather prediction for the second location.

16. The computer program product of claim 15, wherein identifying climate teleconnections comprises:
receiving, by the computing device, at least one hypothesis;
identifying, by the computing device, relevant data associated with a plurality of data codes associated with the first weather event based on the hypothesis; and
generating, by the computing device, a plurality of clusters wherein the plurality of clusters include correlation data associated with the correlating of the first weather event and a second weather event associated with the second location based on the relevant data.

17. The computer program product of claim 16, wherein inputting the first weather event further comprises:
receiving, by the computing device, a temporal shift between the first weather event and a previous weather event; and
identifying, by the computing device, the plurality of data codes associated with the second location within the latent space based on the plurality of clusters.

18. The computer program product of claim 17, wherein inputting the first weather event further comprises:
receiving, by the computing device, a temporal shift between the first weather event and a previous weather event; and
identifying, by the computing device, the plurality of data codes associated with the second location within the latent space based on the plurality of clusters.

19. The computer program product of claim 18, wherein inputting the first weather event further comprises:
storing, by the computing device, the temporal shift in a teleconnections database;
identifying, by the computing device, the plurality of data codes based on at least the temporal shift; and
generating, by the computing device, a plurality of synthetic data associated with the second location based on the identified data codes.

20. The computer program product of claim 19, wherein the teleconnections database is configured to store the climate teleconnections and the climate teleconnections are configured to be crawled utilizing a contrastive neural network.
